(19) United States
(12) Patent Application Publication
(10) Pub. No.: US 2023/0043777 A1
(43) Pub. Date: Feb. 9, 2023

(54) PIN FIXING TYPE HAND TOOL STRUCTURE

(71) Applicants: SHU-YI LO, Zhubei City (TW); Xiang Chen Co., Ltd., Taichung City (TW)

(72) Inventors: SHU-YI LO, Zhubei City (TW); YU-JIE CHEN, Taichung City (TW)

(21) Appl. No.: 17/396,572

(22) Filed: Aug. 6, 2021

(51) Int. Cl. B25G 3/28

(52) U.S. Cl. CPC B25G 3/28

(57) ABSTRACT

A pin fixing type hand tool structure includes a tool head body, a grip body and an abutting fixing block, and cut corners are formed between the tool head body, the grip body and the abutting fixing block and provided for alignment and positioning, so that the three can be stably engaged with one another by the cut corners. The structure is simple and the assembling is convenient, and the production and assembling costs are reduced to achieve high structural stability and assembly convenience.

### FIELD OF THE INVENTION

The present invention relates to a pin fixing type hand tool structure, and more particularly to a hand tool applied for a stable connection of a tool head and a handle.

### BACKGROUND OF THE INVENTION

With reference to FIG. 11 for a conventional hand tool structure, a hand tool 40 of this structure comprises a hammer body 41, a Y-shaped fit fixing grip body 42, a press fastening block 43 and a plurality of locking fasteners 44. The hammer body 41 has a T-slot 410, a locking hole 411 formed on both sides of the T-slot 410 separately, a Y-shaped fit body portion 420 formed on an end side of the Y-shaped fit fixing grip body 42, a positioning portion 421 extending horizontally outward from an end side of the Y-shaped fit body portion 420, a positioning hole 421A formed on the positioning portion 421 and locked with a positioning element a 421B, and a V-shaped elastic abutting groove 422 formed between the positioning portions 421 on both sides of the Y-shaped fit body portion 420 separately. The Y-shaped fit body portion 420 of the Y-shaped fit fixing grip body 42 can be elastically compressed to fit into the T-slot 410 of the hammer body 41, and the T-slot 410 is maintained at the press status after the Y-shaped fit body portion 420 is elastically released, and the positioning portion 421 of the Y-shaped fit body portion 420 will be latched into the T-slot 410 of the hammer body 41, and the positioning hole 421A of the positioning portion 421 is opposite to the locking hole 411 of the T-slot 410, and they are combined and fixed by the positioning member 421B, and the V-shaped elastic abutting groove 422 of the Y-shaped fit body portion 420 is plugged into the press fastening block 43, so that the Y-shaped fix fixing grip body 42 and the hammer body 41 are pressed and held stably. However, the aforementioned structural assembly and components are complicated, and the assembling process is cumbersome, which will increase the production and assembling costs. Obviously, the conventional hand tool structure requires improvements.

### SUMMARY OF THE INVENTION

In view of the poor structural stability and low assembly convenience of conventional hand tool structure, the present invention discloses a pin fixing type hand tool structure to overcome the drawbacks of the prior art.

Therefore, it is a primary objective of the present invention to provide a pin fixing type hand tool structure comprising a tool head body, a grip body and at least one abutting fixing block. The tool head body has a fit fixing slot portion, with an inner latch surface which is a plane or a bevel on a side of the fit fixing slot portion, and an inner abutting surface on the other side of the fit fixing slot portion

The grip body has a wedge-shaped positioning holder with an end side latch surface on a side of the wedge-shaped positioning holder, and the end side latch surface is a plane or a bevel, and a spacing formed on the other opposite side of the end side latch surface, and the wedge-shaped press fastening block has a passing fixing block, and the fit fixing slot portion of the tool head body is larger than the wedge-shaped positioning holder of the grip body, and the fit fixing slot portion of the tool head body is fitted into the wedge-shaped positioning holder of the grip body, and the inner latch surface of the fit fixing slot portion and the end side latch surface of the wedge-shaped positioning holder are abutted and fixed with each other, and the inner abutting surface of the fit fixing slot portion is disposed apart from the spacing of the wedge-shaped positioning holder, and the passing fixing block of the abutting fixing block is passed and fixed to the spacing and abutted between the inner abutting surface of the fit fixing slot portion and the inner surface of the spacing.

In a preferred embodiment, the tool head body is a hammer, an axe or a tool head, and if the tool head body is a hammer, the hammer can be a claw hammer, an octagonal hammer, or any other hammer provided for users to make changes, so as to improve the multi-functionality of the present invention.

In a preferred embodiment, the pin fixing type hand tool structure comprises: a tool head body, having a fit fixing slot portion with an inner latch surface on both sides of the fit fixing slot portion separately; a grip body, having a wedge-shaped positioning holder with an end side latch surface on both sides of the wedge-shaped positioning holder separately, and the fit fixing slot portion of the tool head body is larger than the wedge-shaped positioning holder, and the fit fixing slot portion of the tool head body is fitted into the wedge-shaped positioning holder, and the inner latch surface of the fit fixing slot portion and the end side latch surface of the edge-shaped positioning holder are abutted and fixed to each other, and the inner abutting surface of the fit fixing slot portion is disposed apart from the spacing of wedge-shaped positioning holder, and the passing fixing block of the abutting fixing block is passed and fixed into the spacing and abutted between the inner abutting surface of the fit fixing slot portion and the inner surface of the spacing to improve the symmetrical balanced stability of the assembly and the multi-functionality of the present invention.

In a preferred embodiment, the inner surface of the spacing of the wedge-shaped positioning holder is designed with an embossed pattern, and the surface of the passing fixing block of the butting fixing block is also designed with an embossed pattern, so that the spacing inner surface and the surface of the passing fixing block are in a line contact to increase the latch friction of the structure, so as to achieve a more stable connection and improve the multi-functionality of the present invention.

In a preferred embodiment, the spacing of the wedge-shaped positioning holder of the grip body has an engaging portion which is a bevel cut surface, and the abutting fixing block has an engaging bump which is a bevel bump, and when the wedge-shaped positioning holder of the grip body is fitted to the fit fixing slot portion of the tool head body, the abutting fixing block is plugged between the inner abutting surface of the fit fixing slot portion and the spacing of the wedge-shaped positioning holder, and the engaging bump of the abutting fixing block is aligned and latched with the engaging portion of the spacing of the wedge-shaped positioning holder to provide a stable engagement of the structure, so as to improve the multi-functionality of the present invention.

By the alignment and positioning of the tool head body, the grip body and the abutting fixing block, these components can be fixed and secured stably, and The structure is simple and the assembling is convenient, and the production and assembling costs are reduced to achieve high structural stability and assembly convenience.

### BRIEF DESCRIPTION OF THE DRAWINGS

FIG. 1 is a perspective view of a pin fixing type hand tool structure of this invention;

FIG. 2 is an exploded view of a pin fixing type hand tool structure of this invention;

FIG. 3 is a cross-sectional side view of a pin fixing type hand tool structure of this invention;

FIG. 4 is an exploded view of a pin fixing type hand tool structure applied to different tool head bodies in accordance with a first embodiment of this invention;

FIG. 5 is a cross-sectional side view of pin fixing type hand tool structure as depicted in FIG. 4;

FIG. 6 is a cross-sectional side view showing a pin fixing type hand tool structure applied to different tool head bodies and having two fixed pins in accordance with a second embodiment of this invention;

FIG. 7 is a schematic view showing a pin fixing type hand tool structure having a pin body and a grip body whose bevel surfaces are designed with linear embossed patterns in line contact with each other in accordance with a third embodiment of this invention;

FIG. 8 is a schematic view showing a pin fixing type hand tool structure having a pin body and a grip body whose bevel surfaces are designed with a plurality of bumps in point contact with each other in accordance with a fourth embodiment of this invention;

FIG. 9 is an exploded view showing a pin fixing type hand tool structure applied to an axe with different tool heads in accordance with a fifth embodiment of this invention;

FIG. 10 is a schematic view showing a spacing of a wedge-shaped positioning holder of a pin fixing type hand tool structure having an engaging portion and an abutting fixing block with an engaging bump engaged with each other in accordance with a sixth embodiment of this invention;

FIG. 11 is a cross-sectional side view showing the assembly of a hammer and a handle of a conventional hammer tool.

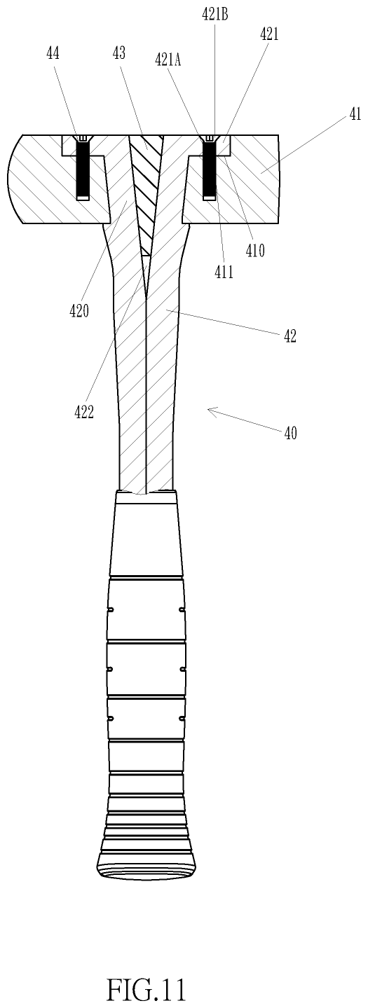

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

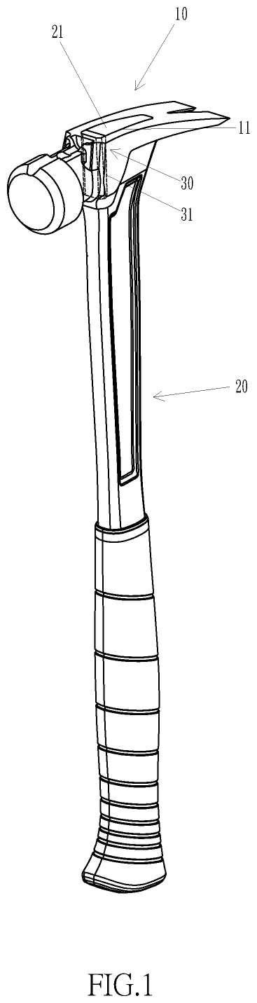

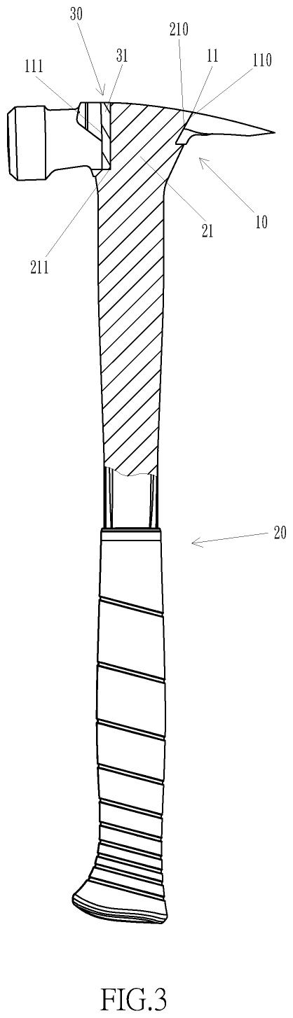

With reference to FIGS. 1 to 3 for the perspective view, exploded view and schematic view of a pin fixing type hand tool structure of the present invention respectively, the pin fixing type hand tool structure comprises: a tool head body 10, having a fit fixing slot portion 11, an inner latch surface 110 which is a plane or a bevel on a side of the fit fixing slot portion 11, and an inner abutting surface 111 on the other side of the fit fixing slot portion 11;

a grip body 20, having a wedge-shaped positioning holder 21, an end side latch surface 210 on a side of the wedge-shaped positioning holder 21, wherein he end side latch surface 210 is a plane or a bevel, and the other side of the end side latch surface 210 having a spacing 211, wherein the fit fixing slot portion 11 of the tool head body 10 is larger than the wedge-shaped positioning holder 21, and the fit fixing slot portion 11 of the tool head body 10 is fitted to the wedge-shaped positioning holder 21, and the inner latch surface 110 of the fit fixing slot portion 11 and the end side latch surface 210 of the wedge-shaped positioning holder 21 being abutted and fixed to each other, and the inner abutting surface 111 of the fit fixing slot portion 11 being disposed apart from the spacing 211 of the wedge-shaped positioning holder 21; and

at least one abutting fixing block 30, having a passing fixing block 31 passed and fixed into the spacing 211, and abutted against the inner abutting surface 111 of the fit fixing slot portion 11 and the inner surface of the spacing 211

The pin fixing type hand tool structure of the present invention is comprised of the aforementioned components.

With reference to FIGS. 1 to 3 for the perspective view, the exploded view, and the cross-sectional side view of a pin fixing type hand tool structure of the present invention, the fit fixing slot portion 11 of the tool head body 10 is larger than the wedge-shaped positioning holder 21 of the grip body 20, and the fit fixing slot portion 11 of the tool head body 10 is fitted into the wedge-shaped positioning holder 21 of the grip body 20, and the inner latch surface 110 of the fit fixing slot portion 11 and the end side latch surface 210 of the wedge-shaped positioning holder 21 are abutted and fixed to each other, and the inner abutting surface 111 of the fit fixing slot portion 11 is disposed apart from the spacing 211 of the wedge-shaped positioning holder 21, and the passing fixing block 31 of the abutting fixing block 30 is passed and fixed into the spacing 211 and abutted against the inner abutting surface 111 of the fit fixing slot portion 11. The tool head body 10, the grip body 20 and the abutting fixing block 30 are provided for alignment and positioning, so that they can be secured and latched stably, so as to achieve the effects of simple structure, easy assembling, low manufacturing and assembling costs, and high structural stability and assembly convenience.

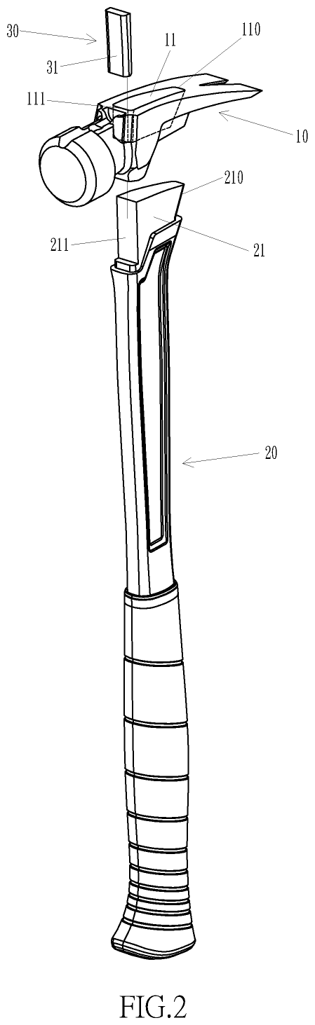

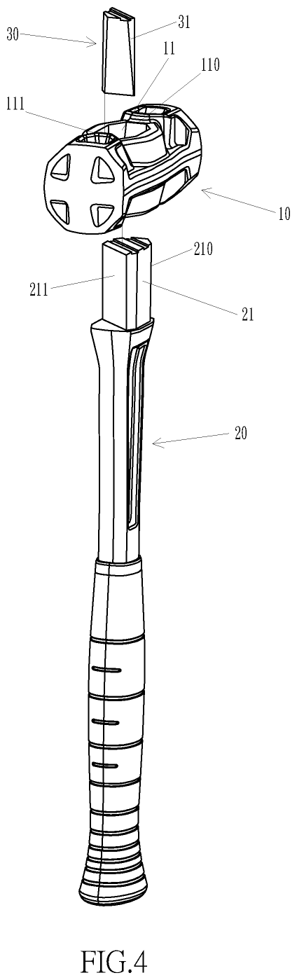

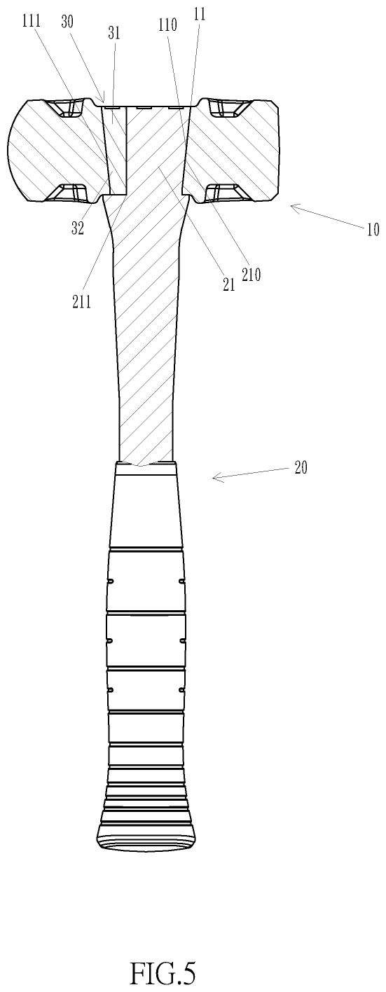

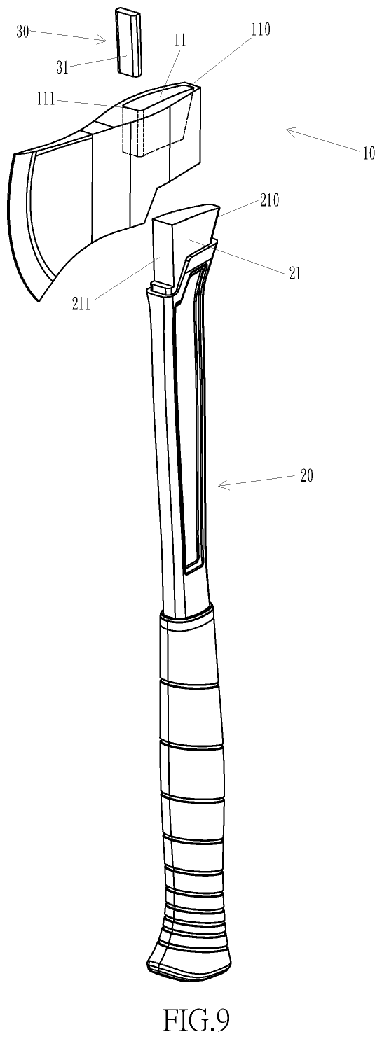

With reference to FIGS. 2, 4, 5 and 9, FIG. 2 is the exploded view of the first embodiment of a pin fixing type hand tool structure applied to a hammer of different tool head bodies and FIG. 4 is the cross-sectional side view of the fifth embodiment of a pin fixing type hand tool structure applied to an axe of different tool head bodies in accordance the present invention, and their overall structures are the same, except that the tool head body 10 can be a hammer, an axe or any other tool head, and when the tool head body 10 is a hammer, the hammer can be a claw hammer, an octagonal hammer, or any other hammer provided for users to make changes, so as to improve the multi-functionality of the present invention.

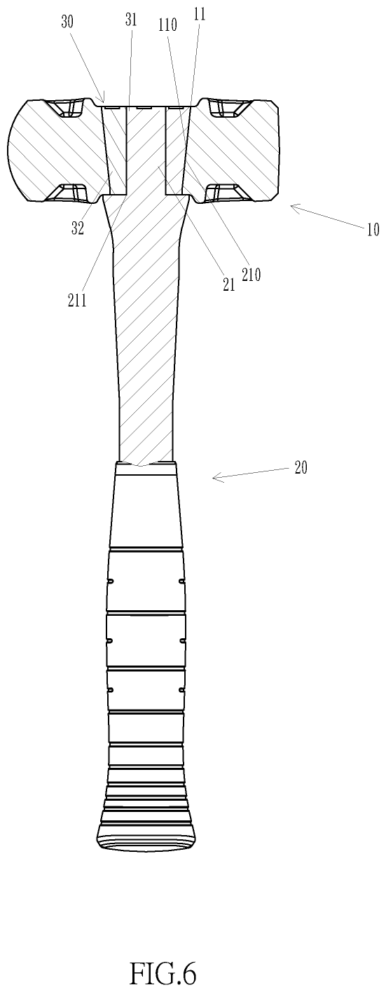

With reference to FIG. 6 for the cross-sectional side view showing a pin fixing type hand tool structure applied to different tool head bodies and having two fixed pins in accordance with a second embodiment of this invention, the pin fixing type hand tool structure comprises: a tool head body 10 having a fit fixing slot portion 11 and an inner latch surface 110 on both sides of the fit fixing slot portion 11 separately; a grip body 20, having a wedge-shaped positioning holder 21, and a spacing 211 on both sides of the wedge-shaped positioning holder 21 separately, wherein the fit fixing slot portion 11 of the tool head body 10 is larger than the wedge-shaped positioning holder 21, and the fit fixing slot portion 11 of the tool head body 10 is fitted to the wedge-shaped positioning holder 21, and the inner latch surface 110 of the fit fixing slot portion 11 is disposed apart from the spacing 21 of the wedge-shaped positioning holder 21; and two abutting fixing blocks 30, each having a passing fixing block 31 passed and fixed into the spacing 211 of the wedge-shaped positioning holder 21 of the grip body 20, wherein the passing fixing block 31 has a side abutting against the inner surface of the spacing 211 and the other side abutting against the inner latch surface 110 of the fit fixing slot portion 11 of the tool head body 10 to improve the symmetrical balanced stability of the structure and improve the multi-functionality of the present invention.

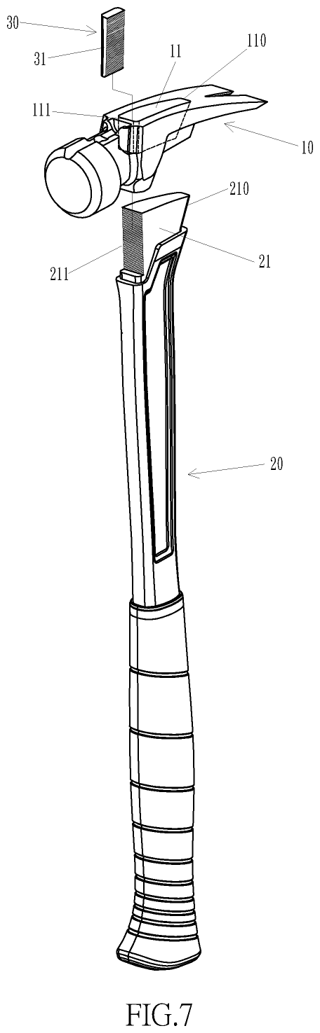

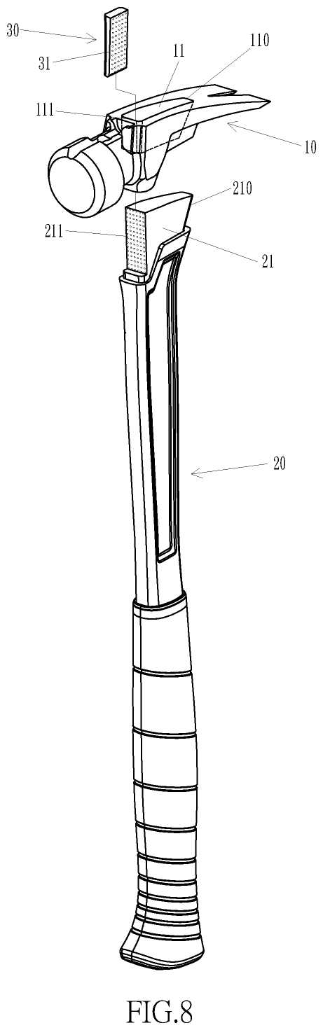

With reference to FIGS. 7 and 8 for the schematic view showing the a pin fixing type hand tool structure of the third embodiment having a pin body and a grip body whose bevel surfaces are designed with linear embossed patterns in line contact with each other and schematic view showing the pin fixing type hand tool structure of the fourth embodiment having a pin body and a grip body whose bevel surfaces are designed with a plurality of bumps in point contact with each other in accordance with this invention respectively, the inner surface of the spacing 211 of the wedge-shaped positioning holder 21 is designed with the embossed pattern or bump, and a surface of the passing fixing block 31 of the abutting fixing block 30 is also designed with an embossed pattern or a bump, so that the inner surface of the spacing 211 and the surface of the passing fixing block 31 are in a line contact or point contact to increase the latch friction of the structure, so as to provide a more stable structure and improve the multi-functionality of the present invention.

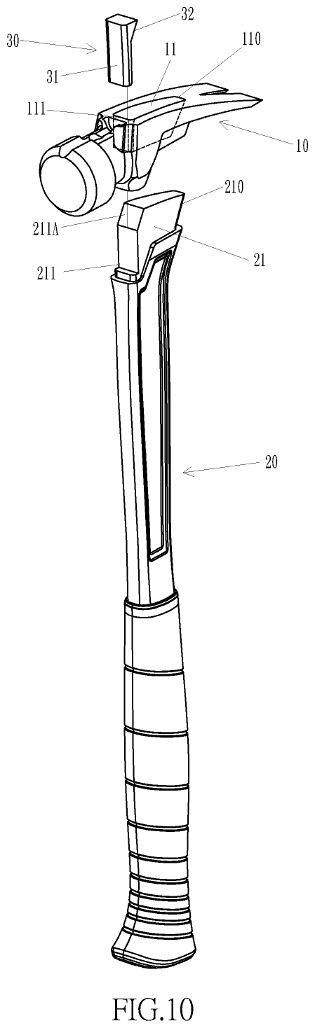

With reference to FIG. 10 for a schematic view showing a spacing of a wedge-shaped positioning holder of a pin fixing type hand tool structure having an engaging portion and an abutting fixing block with an engaging bump engaged with each other in accordance with the sixth embodiment of this invention, the spacing 211 of the wedge-shaped positioning holder 21 of the grip body 20 has an engaging portion 211A which is a bevel cut surface, and the abutting fixing block 30 has an engaging bump 32 which is a bevel bump. When the wedge-shaped positioning holder 21 of the grip body 20 is fitted to the fit fixing slot portion 11 of the tool head body 10, the abutting fixing block 30 is plugged between the inner abutting surface 111 of the fit fixing slot portion 11 and the spacing 211 of the wedge-shaped positioning holder 21, and the engaging bump 32 of the abutting fixing block 30 is aligned and latched with the engaging portion 211A of the spacing 211 of the wedge-shaped positioning holder 21 to provide a stable structure and achieve the multi-functionality of the present invention.

In summation of the description above, the present invention definitely can achieve the aforementioned functions and objectives, and comply with patent application requirements, and thus is duly filed for patent application.

What is claimed is:

1. A pin fixing type hand tool structure, comprising:
a tool head body, having a fit fixing slot portion, with an inner latch surface on a side of the fit fixing slot portion, and an inner abutting surface on the other side of the fit fixing slot portion;
a grip body, having a wedge-shaped positioning holder, an end side latch surface on a side of the wedge-shaped positioning holder, a spacing formed on the other side of the end side latch surface, and the fit fixing slot portion of the tool head body being larger than the wedge-shaped positioning holder, and the fit fixing slot portion of the tool head body being fitted on the wedge-shaped positioning holder, and the inner latch surface of the fit fixing slot portion and the end side latch surface of the wedge-shaped positioning holder being latched and fixed with each other, and the inner abutting surface of the fit fixing slot portion being disposed apart from the spacing of the wedge-shaped positioning holder; and
at least one abutting fixing block, having a passing fixing block passed and fixed to the spacing and abutting between the inner abutting surface of the fit fixing slot portion and the inner surface of the spacing.

2. The pin fixing type hand tool structure according to claim 1, wherein the tool head body is a hammer, an axe or a tool head, and if the tool head body is a hammer, the hammer can be a claw hammer, an octagonal hammer, or a hammer of another form.

3. The pin fixing type hand tool structure according to claim 1, wherein the inner surface of the spacing of the wedge-shaped positioning holder is designed with an embossed pattern, and the surface of the passing fixing block of the butting fixing block is also designed with an embossed pattern, so that the inner surface of the spacing and the surface of the passing fixing block are in a line contact to increase the latch friction of the structure.

4. The pin fixing type hand tool structure according to claim 1, wherein the inner surface of the spacing of the wedge-shaped positioning holder is designed with a bump, and the surface of the passing fixing block of the abutting fixing block are also designed with a bump, so that the inner surface of the spacing and the surface of the passing fixing block are in a point contact to increase the latch friction of the structure.

5. The pin fixing type hand tool structure according to claim 1, wherein the spacing of the wedge-shaped positioning holder of the grip body has an engaging portion thereon, and the abutting fixing block has an engaging bump thereon, and when the wedge-shaped positioning holder of the grip body is fitted to the fit fixing slot portion of the tool head body, the abutting fixing block is plugged between the inner abutting surface of the fit fixing slot portion and the spacing of the wedge-shaped positioning holder, and the engaging bump of the abutting fixing block is aligned and latched with the engaging portion of the spacing of the wedge-shaped positioning holder to provide a stable engagement of the structure.

6. A pin fixing type hand tool structure, comprising:
a tool head body, having a fit fixing slot portion with an inner latch surface on both sides of the fit fixing slot portion separately;
a grip body, having a wedge-shaped positioning holder with a spacing on both sides of the wedge-shaped positioning holder separately, and the fit fixing slot portion of the tool head body being larger than the wedge-shaped positioning holder, and the fit fixing slot portion of the tool head body being fitted to the wedge-shaped positioning holder, and the inner latch surface of the fit fixing slot portion being disposed apart from the spacing of the wedge-shaped positioning holder; and
two abutting fixing blocks, each having a passing fixing block passed and fixed to the spacing of the wedge-shaped positioning holder of the grip body, and the passing fixing block having a side abutting against the inner surface of the spacing and the other side abutting against the inner latch surface of the fit fixing slot portion of the tool head body.

7. The pin fixing type hand tool structure according to claim 6, wherein the tool head body is a hammer, an axe or a tool head, and when the tool head body is a hammer, the hammer is a claw hammer, an octagonal hammer, or a hammer of another form.

8. The pin fixing type hand tool structure according to claim 6, wherein the inner surface of the spacing of the wedge-shaped positioning holder is designed with an embossed pattern, and the surface of the passing fixing block of the abutting fixing block is also designed with an embossed pattern, so that the inner surface of the spacing and the surface of the passing fixing block are in a line contact to increase the latch friction of the structure.

9. The pin fixing type hand tool structure according to claim 6, wherein the inner surface of the spacing of the wedge-shaped positioning holder is designed with a bump, and the surface of the passing fixing block of the abutting fixing block is also designed with a bump, so that the inner surface of the spacing and the surface of the passing fixing block are in a point contact to increase the latch friction of the structure.
